(19) United States
(12) Patent Application Publication
(10) Pub. No.: US 2016/0116891 A1
(43) Pub. Date: Apr. 28, 2016

(54) METHOD AND DEVICE FOR OPERATING A HOUSEHOLD APPLIANCE AND HOUSEHOLD APPLIANCE

(71) Applicant: Miele & Cie. KG, Guetersloh (DE)

(72) Inventors: Andree Megger, Neuenkirchen (DE); Alfons Eblenkamp, Rietberg (DE)

(21) Appl. No.: 14/886,113

(22) Filed: Oct. 19, 2015

(30) Foreign Application Priority Data
Oct. 23, 2014 (DE) 10 2014 115 460.6

(51) Int. Cl. G05B 15/02; G06F 3/01

(52) U.S. Cl. CPC G05B 15/02; G06F 3/017

(57) ABSTRACT

A method for operating a household appliance having at least one sensor for detecting a user of the household appliance includes evaluating a movement of the user sensed by the sensor; providing a switch-on signal to place the household appliance in a state of operational readiness if, in the evaluating step, the movement is recognized as an approaching movement relative to the household appliance that is sensed in a predetermined first sensing region; and outputting an activation signal to activate a control-movement recognition function of the household appliance using the switch-on signal if, in the evaluating step, the movement is recognized as an approaching movement relative to the household appliance that is sensed in a predetermined second sensing region.

### CROSS-REFERENCE TO PRIOR APPLICATION

Priority is claimed to German Patent Application No. DE 10 2014 115 460.6, filed on Oct. 23, 2014, the entire disclosure of which is hereby incorporated by reference herein.

### FIELD

The present invention relates to a method for operating a household appliance, a corresponding apparatus, a household appliance, as well as a corresponding computer program.

### BACKGROUND

Currently, household appliances are generally touch-controlled via switches, buttons or touch screens.

### SUMMARY

A method for operating a household appliance having at least one sensor for detecting a user of the household appliance includes evaluating a movement of the user sensed by the sensor; providing a switch-on signal to place the household appliance in a state of operational readiness based on, in the evaluating step, the movement being recognized as an approaching movement relative to the household appliance that is sensed in a predetermined first sensing region; and outputting an activation signal to activate a control-movement recognition function of the household appliance using the switch-on signal based on, in the evaluating step, the movement being recognized as an approaching movement relative to the household appliance that is sensed in a predetermined second sensing region.

### BRIEF DESCRIPTION OF THE DRAWINGS

The present invention will be described in even greater detail below based on the exemplary figures. The invention is not limited to the exemplary embodiments. Other features and advantages of various embodiments of the present invention will become apparent by reading the following detailed description with reference to the attached drawings which illustrate the following:

FIG. 1 is a schematic view of a household appliance according to an exemplary embodiment of the present invention;

FIG. 2 is a schematic view of a control panel of a household appliance according to an exemplary embodiment of the present invention;

FIG. 3 is a block diagram of a sensor system for user detection according to an exemplary embodiment of the present invention;

FIG. 4 is a flow chart of an algorithm for evaluating sensor signals using an apparatus according to an exemplary embodiment of the present invention;

FIG. 5 is a flow chart of a method for operating a household appliance according to an exemplary embodiment of the present invention; and

FIG. 6 is a block diagram of an apparatus for operating a household appliance according to an exemplary embodiment of the present invention.

### DETAILED DESCRIPTION

The approach proposed here provides a method for operating a household appliance having at least one sensor for detecting a user of the household appliance, the method including the following steps:

evaluating a movement of the user sensed by the sensor;

providing a switch-on signal for placing the household appliance in a state of operational readiness if, in the evaluating step, the movement is recognized as an approaching movement relative to the household appliance that is sensed in a predetermined first sensing region.

outputting an activation signal for activating a control-movement recognition function of the household appliance using the switch-on signal if, in the evaluating step, the movement is recognized as an approaching movement relative to the household appliance that is sensed in a predetermined second sensing region.

A household appliance may be understood to be a baking oven, a steam cooker, a fully automatic coffee maker, an exhaust hood, a cooktop, an automatic washing machine, a laundry dryer, a dishwasher, or a refrigeration appliance, for example. The sensor may, for example, be a sensor for optical distance measurement, for example, by infrared triangulation, propagation time measurement or phase relationship measurement, or may also be a capacitive sensor, an ultrasonic sensor, or a radar sensor. The sensor may have at least two different sensing regions for sensing a movement of the user. The sensing regions may differ in their sensing direction, range, and opening angle. Depending on the particular embodiment, movement at a distance of, for example, more than 1, 2 or 5 m from the household appliance may be sensed in the first sensing region, and movement at a distance of, for example, less than 1, 2 or 5 m from the household appliance may be sensed in the second sensing region. A movement may be understood to be a discrete movement or a sequence of movements. The movement may be continuously evaluated in the evaluating step to detect an approach of the user to the household appliance within at least one of two sensing regions. The approaching movement may, for example, be detected even if only a part of the user's body moves toward the household appliance. In other words, the evaluating step may be repeated continuously to evaluate successive movements of the user.

A switch-on signal may be understood to be a signal that serves to place the household appliance in a state of operational readiness. The switch-on signal may be used, for example, to switch on the household appliance or to switch it from an idle state, such as a power-saving mode, to the state of operational readiness.

An activation signal may be understood to be a signal that serves to activate a control-movement recognition function of the household appliance. In particular, the activation signal may be output in the outputting step, provided the household appliance is already in the state of operational readiness. If this is not the case, the outputting of the activation signal may, for example, be suppressed even if, in the evaluating step, the approaching movement is detected in the second sensing region.

A control-movement recognition function may be understood to be an operating mode of the household appliance that enables the household appliance to detect non-contact control movements of the user. A control movement may be understood to be a specific movement of the hand, finger or arm, for example, for controlling the household appliance, such as a swiping gesture, an approaching gesture or a receding gesture performed by the user without touching the household appliance.

The control movement may also be, for example, a nonspecific approach of a body part of the user, such as a head or a hand, to the household appliance. The movement of the user may be recognized as a control movement by the control-movement recognition function, in particular if the movement is sensed in the second sensing region.

The approach presented herein is based on the realization that an approach of a person to a household appliance can be detected by sensor means to enable the appliance to be controlled by simple gestures, such as approaching gestures or swiping gestures in front of the household appliance.

In this context, it is possible, for example, to combine an approaching gesture with presence detection. This allows the household appliance to be controlled in an intuitive, simple and convenient manner without the person having to search for suitable buttons or switches.

To permit robust detection of an approach or simple gestures, it is advantageously possible to use a resource-saving, inexpensive sensor system without complex image processing, thereby eliminating the need for expensive camera systems. Thus, the approach presented herein can be implemented with relatively little technical and economic effort.

Presence detection may also be used, for example, as a complement to voice control of the household appliance, for example, in that the voice control is only activated when the person is detected.

Last but not least, an additional control option allowing control via simple gestures can create an inspiring user experience.

In accordance with an embodiment, the first sensing region may be farther away from the household appliance than the second sensing region. This allows movement of the user to be detected in two stages according to a distance of the user from the household appliance. For example, an approach of the user from a greater distance may be detected in a first stage associated with the first sensing region, and an approach of the user from a smaller distance may be detected in a second stage associated with the second sensing region.

It is also advantageous if, in the outputting step, the activation signal is output if, in the evaluating step, the movement is recognized as an approaching movement of a body part of the user relative to the household appliance that is detected in the second sensing region. A body part may be, for example, a finger, a hand, an arm or a head of the user. This allows the movement to be evaluated in a differentiated manner so as to detect, for example, discrete movements of the user, in particular during progressive motion of the user.

It is also advantageous if the switch-on signal is provided in the providing step and, additionally or alternatively, the activation signal is output in the outputting step if, in the evaluating step, the movement is recognized as an approaching movement relative to the household appliance that lasts for a predetermined approach period. An approach period may be understood to be a minimum period of time for which the approaching movement is required to last in order to be recognizable as an approaching movement. The approach period may be, for example, between 0.8 s and 2 s. This makes it possible to distinguish, with high reliability, a deliberate approaching movement from an inadvertent approaching movement, for example, when the user walks obliquely past the household appliance.

The method may be provided with a step of generating a change signal for changing a display and, additionally or alternatively, a signal tone volume of the household appliance, using either the switch-on signal or the activation signal, or both signals. A display may be understood to be, for example, a screen or an illuminated field for displaying information about an operating mode, time, or other information the user may be interested in. A signal tone volume may be understood to be a volume at which the household appliance emits signal tones, for example, when the operating mode is changed.

The household appliance may, for example, be adapted to control the signal tone volume as a function of a distance of the user from the household appliance. Using the change signal, it can be achieved, for example, that the display is not activated until the user is near the household appliance. This makes it possible to reduce the power consumption of the household appliance.

Further, the method may include a step in which a further movement of the user sensed by the sensor is analyzed by the control-movement recognition function using the activation signal. In this context, in a generating step, a control signal for controlling the household appliance may be generated if, in the analyzing step, the further movement is recognized as a control movement for non-contact control of the household appliance. The further movement may be, for example, a movement that is subsequent to a movement evaluated in the evaluating step. The movement and the further movement may, for example, be partial movements of one and the same sequence of movements of the user, which may include, for example, the approaching movements sensed in the two sensing regions and the control movement. In this context, as mentioned earlier, the control movement may again be an approaching movement of the user, in particular of a body part of the user, or also an explicit gesture. Such a combination of presence detection and control-movement recognition makes it possible to prevent erroneous control inputs due to unintentional gestures.

Advantageously, in the generating step, the control signal may be generated if, in the analyzing step, the further movement is recognized as a control movement that is sensed in the second sensing region. The second sensing region may in particular be a proximate region in which movements at a distance of, for example, less than 20 cm or less than 50 cm from the household appliance can be sensed. By detecting the control movement in the second sensing region, movements that are performed outside the second sensing region but within the first sensing region can be prevented from being erroneously recognized as control movements.

Further, in the generating step, the control signal may be generated if, in the analyzing step, the further movement is recognized as a control movement that lasts for a predetermined control operation period. A control operation period may be understood to be a minimum period of time for which the control movement is required to last in order to be recognizable as a control movement. The control operation period may be, for example, between 0.5 s and 2 s. This embodiment, too, allows the recognition performance of the household appliance to be improved.

In the outputting step, at least one further control signal for controlling the household appliance may be output using the switch-on signal if, in the evaluating step, the movement is recognized as an approaching movement relative to the household appliance that is sensed in at least one predetermined further sensing region. This makes it possible to improve the ease of use of the household appliance.

In accordance with another embodiment, the further sensing region may be oriented in a different direction than the first sensing region, in a different direction than the second sensing region, or in a different direction than the first and second sensing regions. A sensing direction of the further sensing region may, for example, differ by 10, 45 or 90 degrees from a respective sensing direction of the first or second sensing region. This allows the total sensing area of the household appliance to be significantly increased.

Further, in the evaluating step, at least one additional movement of the user sensed by the sensor may be evaluated. In a sending step, at least one additional control signal for controlling the household appliance may be sent if, in the evaluating step, the additional movement is recognized as a receding movement relative to the household appliance. Such automated control of the household appliance makes it possible to reduce the number of control operations to be manually performed by the user, and thus to increase the ease of use.

The approach presented herein further provides an apparatus adapted to perform all steps of a method in accordance with at least one of the aforedescribed embodiments.

In the present context, an apparatus may be understood to be an electrical device that processes sensor signals and outputs control and/or data signals as a function thereof. The apparatus may have an interface which may be implemented in hardware and/or software. When implemented in hardware, the interfaces may, for example, be part of a so-called “system ASIC” including diverse functions of the apparatus. However, the interfaces may also be separate integrated circuits or may be at least partly composed of discrete components. When implemented in software, the interfaces may be software modules that are present, for example, on a microcontroller in addition to other software modules.

The approach proposed herein further provides a household appliance having an apparatus in accordance with one of the aforedescribed embodiments and at least one sensor for detecting a user of the household appliance.

Also advantageous is a computer program product or computer program having program code, which may be stored on a machine-readable carrier or storage medium, such as a semiconductor memory, a hard-disk memory or an optical memory, and is used to carry out, implement and/or control the steps of the method in accordance with one of the aforedescribed embodiments, particularly when the program product or program is executed on a computer or an apparatus.

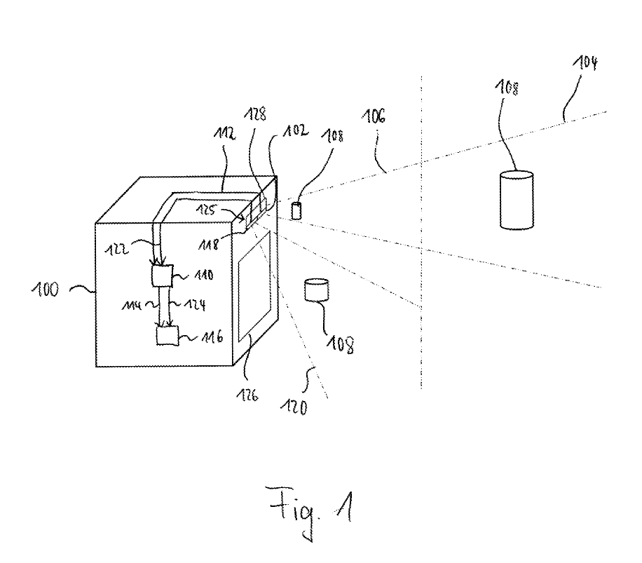

FIG. 1 shows, in schematic view, a household appliance 100 according to an exemplary embodiment of the present invention. Household appliance 100 includes a sensor 102 which, by way of example, is incorporated into a front of household appliance 100. In accordance with this exemplary embodiment, sensor 102 has a sensing region which is divided into a remote region 104 and a proximate region 106, remote region 104 and proximate region 106 having a common sensing direction. Sensor 102 is adapted to continuously sense movement of a user 108 of household appliance 100 in regions 104, 106 and to provide corresponding sensor signals 112.

Household appliance 100 includes an apparatus 110 adapted to receive sensor signals 112 and to evaluate the movement of user 108 using sensor signals 112. If an evaluation of sensor signals 112 shows that user 108 is approaching household appliance 100 within remote region 104, then apparatus 110 initially places household appliance 100 in a state of operational readiness.

In response to the activation of household appliance 100, apparatus 110 performs a further evaluation of the user movement using sensor signals 112. If the further evaluation shows that user 108 is now approaching household appliance 100 within proximate region 106 as well, then apparatus 110 activates a control-movement recognition function of household appliance 100. Using the control-movement recognition function, it is possible to detect gestures for non-contact control of household appliance 100. In FIG. 1, the control-movement recognition function is implemented as a feature of apparatus 110. Alternatively, the control-movement recognition function may also be implemented as a feature of a separate electronic component.

Using the activated control-movement recognition function, apparatus 110 re-evaluates the user movement using sensor signals 112. If, during this re-evaluation, a control movement for non-contact control of household appliance 100 is detected, then apparatus 110 generates a control signal 114 for controlling household appliance 114 that corresponds to the detected control movement. Apparatus 110 may in particular be adapted to detect the control movement when sensor signals 112 represent a user movement sensed in proximate region 106.

In the exemplary embodiment shown in FIG. 1, the household appliance has a controller 116 adapted to receive control signal 114 from apparatus 110 and to control household appliance 100 using control signal 114. Alternatively, household appliance 100 may also be controlled directly by apparatus 110 via control signal 114.

In FIG. 1, household appliance 100 is exemplarily configured with a further sensor 118 that is adapted to detect user 108 in a further sensing region 120 and to transmit corresponding further sensor signals 122 to apparatus 110 in a manner analogous to sensor 102. By way of example, further sensing region 120 is here oriented angularly downwardly, and thus in a sensing direction that differs from the sensing direction of regions 104, 106. Apparatus 110 is adapted to evaluate further sensor signals 122. If the evaluation of further sensor signals 122 shows that user 108 is approaching household appliance 100 within further sensing region 120, then apparatus 110 provides a further control signal 124 for controlling household appliance 100 that is received and processed by controller 116 in a manner analogous to control signal 114.

FIG. 1 depicts a sensor system and a sensing region of sensors 102, 118 in accordance with an exemplary embodiment of the present invention. Sensors 102, 118, here optical sensors, are disposed behind a control panel 125 of household appliance 100. A glass pane of control panel 125 has an infrared-transmitting coating in the region of sensors 102, 118. Depending on the arrangement and design of sensors 102, 118, different sensing regions may be implemented. This allows multi-stage detection of user 108. An optical measurement system including, for example, apparatus 110 and sensors 102, 118, is adapted to detect user 108 approaching within remote region 104 in a first stage and to sense gestures within proximate region 106 in a second stage. Additional region 120 may serve, for example, to detect approaches in front of an appliance door 126.

As mentioned earlier, household appliance 100 is placed in operational readiness in response to user 108 moving toward household appliance 100 within remote region 104. Depending on the particular embodiment, operational readiness may be simulated visually, for example, by turning on a cooking chamber light, or audibly. When household appliance 100 is in the state of operational readiness, it may also be controlled by simple gestures in the near field of a display 128 in addition to a standard control method. In FIG. 1, display 128 is disposed, by way of example, in the region of control panel 125. Apparatus 110 may be adapted to switch a display, for example, from a time display mode to an operating mode selection mode in response to user 108, or a body part of user 108, such as a hand, approaching display 128 within proximate region 106. User 108 may move the contents of the display, for example, by swiping gestures to the left or right, in a corresponding direction. Further sensor 118, which here is oriented angularly downwardly, serves to detect user 108 in front of appliance door 126. In this way, the head of user 108 can be detected, for example, when the user looks into a cooking chamber of household appliance 100. Apparatus 110 may be adapted to switch on an interior light of the appliance in response to detecting user 108.

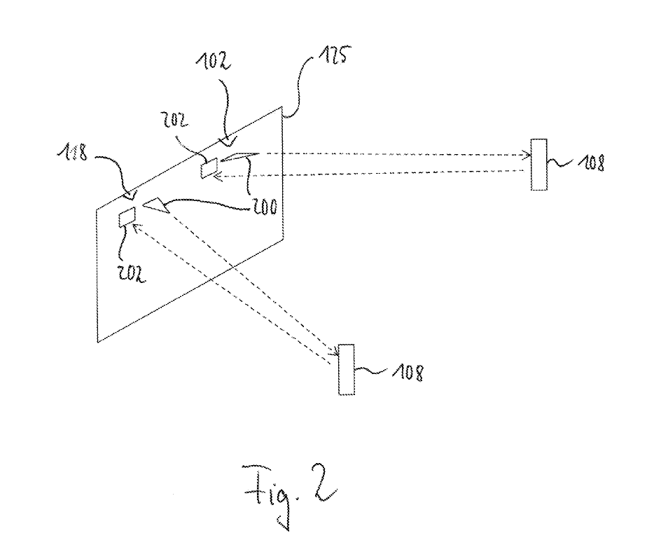

FIG. 2 shows, in schematic view, a control panel 125 of a household appliance according to an exemplary embodiment of the present invention. The household appliance may, for example, be a household appliance such as that described with reference to FIG. 1. FIG. 2 illustrates a possible arrangement and orientation of sensors 102, 118, where sensors 102, 118 are disposed behind control panel 125. In accordance with this exemplary embodiment, sensors 102, 118 are implemented as optical sensors and each have at least one infrared-emitting LED (in short, IRED) as an emitter 200 and a photodiode as a receiver 202. In the region of sensors 102, 118, control panel 125 is transmissive to infrared light. Depending on the orientation and design of emitters 200, objects, such as user 108, may be detected in different regions and ranges.

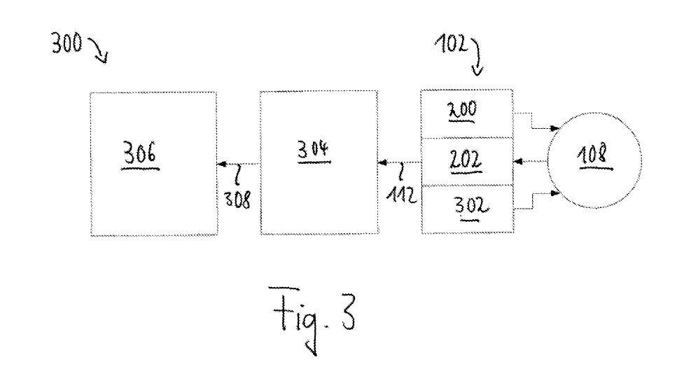

FIG. 3 shows a block diagram of a sensor system 300 for user detection according to an exemplary embodiment of the present invention. Sensor system 300 includes an optical sensor 102, which substantially corresponds to the sensor 102 described with reference to FIG. 2. In contrast to FIG. 2, sensor 102 has an optional additional emitter 302 in addition to emitter 200 and receiver 202. Emitters 200, 302 emit infrared light. Due to reflection or scattering at an object, such as, for example, user 108, a portion of the infrared light is returned to receiver 202, which may be a photodiode. A conditioning unit 304 coupled to optical sensor 102 serves to condition sensor signals 112 provided by optical sensor 102. A microcontroller 306 having an evaluation algorithm is adapted to receive correspondingly conditioned signals 308 from conditioning unit 304 and to use the conditioned signals 308 to detect approaches, directions of movement, or gestures of user 108, using known methods of optical distance measurement, for example, by infrared triangulation, propagation time measurement or phase relationship measurement. By detecting approach and direction of movement, it is possible, for example, to ignore a person walking past the household appliance.

Through the use of two emitters 200, 302, it is possible to detect swiping gestures and to distinguish between passing-by and approaching persons. Additional emitter 302 may be disposed to cover farther distances or other regions in front of the household appliance.

Conditioning unit 304 and microcontroller 306 may be part of the apparatus described with reference to FIGS. 1 and 2.

Depending on the particular embodiment, sensor system 300 may alternatively, or additionally, be configured with capacitive sensors, ultrasonic sensors, or radar sensors to sense and evaluate the movement of user 108 in a similar manner.

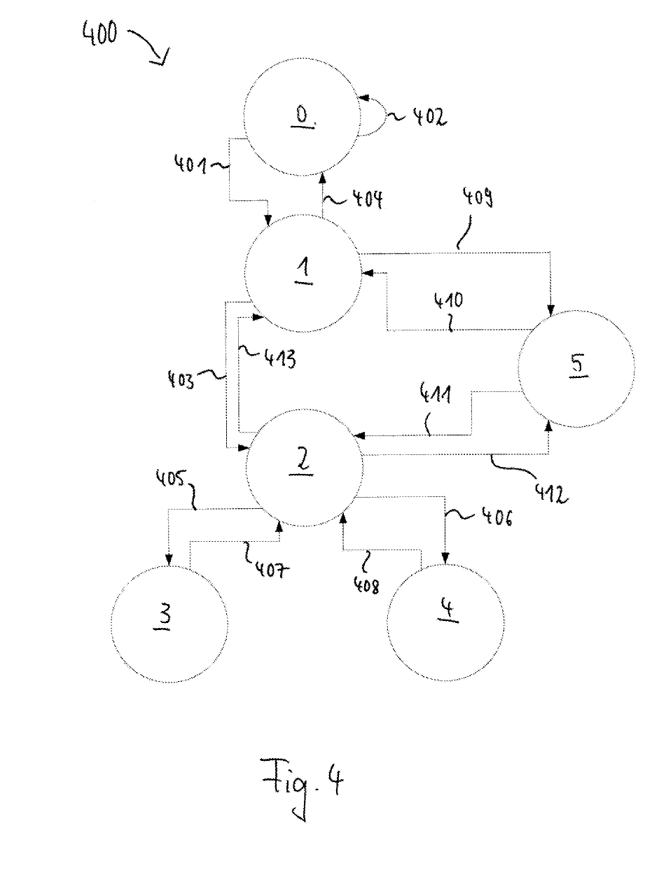

FIG. 4 shows a flow chart of an algorithm 400 for evaluating sensor signals using an apparatus according to an exemplary embodiment of the present invention. The apparatus may, for example, be an apparatus such as that described with reference to FIGS. 1 through 3. Algorithm 400 may be executed by a microcontroller of the apparatus, which microcontroller is described with reference to FIG. 3.

FIG. 4 shows a possible embodiment of algorithm 400. First, an approach of a person is detected. In a second step, gestures are detected in a proximate region or an additional region.

The evaluation of the sensor signals by means of algorithm 400 begins in a state 0, also called idle state. In a step 401, state 0 is exited in the direction of a state 1 only if a person approaching the household appliance is detected. The approach may be detected by a sensor A or a sensor B of the household appliance. Sensors A, B may be the sensors described with reference to FIGS. 1 through 3. If nothing is detected by sensor A or sensor B, or if a person moving laterally with respect to the household appliance is detected, then activation of state 1 is suppressed in a step 402; i.e., algorithm 400 remains in state 0 if a person is detected to be walking by.

In state 1, operational readiness of the household appliance may be indicated visually or audibly. From this point on, it is possible to interpret further gestures. State 1 may change to a state 2 or to a state 5 if the distance falls below certain thresholds. For example, in a step 403, state 1 changes to state 2 if an approach of the person, particularly of a body part of the person, such as a hand, is sensed by sensor A at a distance of less than 20 cm or less than 25 cm. However, it nothing is detected by the two sensors A, B in state 1 and a predetermined time T has elapsed during which no person is detected anymore, then state 1 changes back to state 0 in a step 404.

In step 403, for example, an approaching gesture is sensed in front of a display of the household appliance. As a result, state 2 is activated. The distance of the person, here, for example, the hand, from sensor A is here less than the predefined threshold distance of, for example, 20 cm or 25 cm. As a possible action, the appliance display may change from time display to operating mode selection display.

If, in state 2, sensor A detects a swiping gesture to the left, then, in a step 405, state 2 changes to a state 3 for a predetermined period of time X in the millisecond range. If, in state 2, sensor A detects a swiping gesture to the right, then, in a step 406, a state 4 is activated for period of time X. After period of time X elapses, state 3 changes back to state 2 in a step 407 or state 4 changes back to state 2 in a step 408, respectively. Depending on the gesture detected, the display contents may, for example, be scrolled left or right.

State 5 is suitable in particular as an option for cooking appliances. A separate emitter in the form of sensor B is oriented such that a body part of the person, here, for example, a head, is detected at a distance of about 50 cm in front of a cooking chamber door of a baking oven or steam cooker. As a possible action, a cooking chamber light may be turned on in state 5.

If the household appliance is in the state of operational readiness 1 and sensor B detects the head in front of the cooking chamber door, then, in a step 409, state 1 changes to state 5.

If, in state 5, sensor B detects that the head is distant by more than 50 cm plus a hysteresis, then, in a step 410, state 5 changes back to state 1.

If, in state 5, sensor A detects that the head is distant by less than 20 cm, then, in a step 411, state 2 is activated.

If, in state 2, sensor A detects that the hand or the head is located at a distance greater than 20 cm plus a hysteresis and sensor B detects that the distance is smaller than 50 cm, then, in a step 412, state 2 again changes to state 5.

However, if in state 2, sensor A detects that the distance is greater than 20 cm plus a hysteresis and sensor B detects that the distance is greater than 50 cm, then, in a step 413, state 2 changes back to state 1.

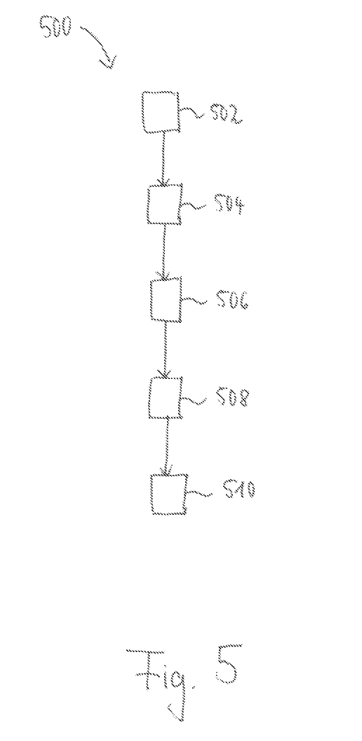

FIG. 5 shows a flow chart of a method 500 for operating a household appliance having at least one sensor for detecting a user of the household appliance, in accordance with an exemplary embodiment of the present invention. Method 500 may be carried out, for example, by devices of an apparatus such as that described with reference to FIGS. 1 through 4. In a step 502, a movement of the user sensed by the sensor is evaluated. The sensing of the movement may be part of the method. Alternatively, information about the movement sensed by the sensor may be read in via an interface. If the sensed movement is recognized as an approaching movement relative to the household appliance that is sensed in a predetermined first sensing region, then, in a step 504, a switch-on signal is provided which serves to place the household appliance in a state of operational readiness. However, if in step 502, the movement is recognized as an approaching movement relative to the household appliance that is sensed in a predetermined second sensing region, then, in a step 506, an activation signal is output using the switch-on signal, the activation signal serving to activate a control-movement recognition function of the household appliance. Thus, outputting step 506 is only carried out if the household appliance is in the state of operational readiness. Evaluating step 502 may, for example, be carried out continuously during providing step 504, or be carried out again in response to the provision of the switch-on signal so as to evaluate the movement of the user with respect to an approach in the second sensing region.

In accordance with an exemplary embodiment, following step 506, a step 508 is carried out in which a further movement of the user sensed by the sensor is analyzed by the control-movement recognition function, using the activation signal. If the analysis shows that the further movement is a control movement for non-contact control of the household appliance, then, in a step 510, a control signal for controlling the household appliance is generated.

To prevent erroneous detection, for example, the generation of the switch-on signal in step 504 or of the activation signal in step 506 or of the control signal in step 510 is only effected if, in the case of the switch-on and activation signals, the movement is recognized in step 502 as an approaching movement that lasts at least for a predetermined approach period or if, in the case of the control signal, the further movement is recognized in step 508 as a control movement that lasts at least for a predetermined control operation period.

In accordance with another exemplary embodiment, generation of the activation signal in step 506, respectively of the control signal in step 510, is only effected under the additional or alternative condition that in step 502, the movement is recognized as an approaching movement that is sensed within the second sensing region, respectively that in step 508, the further movement is recognized as a control movement that is sensed within the second sensing region. The second sensing region may here in particular represent a proximate region with a detection range of, for example, up to 50 cm or up to 80 cm from the household appliance.

Method 500 for sensor-assisted, non-contact control of a household appliance is fundamentally based on the detection of approaches from information about a distance of an object from a sensor and, when multiple sensors are used, on the detection of swiping gestures from a light distribution. After a gesture is identified, a corresponding action is performed in the household appliance.

Depending on the arrangement and design of the sensors, a sensing region of the household appliance may be divided into a plurality of regions, as shown in FIG. 1. The division into different sensing regions allows multi-stage detection of gestures, as described in more detail hereinabove.

In the following, different operating scenarios; i.e., different gestures and actions that may be triggered by such gestures, will be illustrated by the example of built-in appliances, such as a baking oven, steam cooker or fully automatic coffee maker. Depending on the particular embodiment, the described sensing of gestures may also be used in other household appliances, such as in automatic washing machines, laundry dryers or dishwashers, with similar or modified actions.

In a first scenario, the household appliance, here a baking oven, steam cooker or fully automatic coffee maker, detects, via a sensor in a control panel, that a person is walking past the appliance in the remote region. The household appliance ignores the person and remains in its current state.

In a second scenario, the household appliance detects, via the sensor in the control panel, that the person is approaching the appliance. The person is located at a distance within the remote region of the sensor, in particular in a range of between 1 m and 2 m in front of the appliance. To permit robust detection of an approach, the person should be approaching the appliance in the remote region for a period of at least 800 ms. The household appliance indicates operational readiness visually or audibly. The display changes from time display to operating modes. The signal tones of the appliance decrease in volume.

In a third scenario, after detecting the approach, the household appliance detects, via the sensor in the control panel, that a person leans against the appliance in the proximate region. The household appliance ignores the detection of gestures in the proximate region until the person no longer leans against the appliance.

In a fourth scenario, the household appliance detects, via the sensor in the control panel, an approach of a hand. The hand is located at a distance within the proximate region of the sensor. The approach of the hand should here be sensed for a period of from 100 ms to 500 ms, in particular 200 ms, in a sensing region between 25 cm and 5 cm in front of the appliance. The display of the household appliance turns on. The display changes from time display to operating modes. The signal tones of the appliance decrease in volume.

In a firth scenario, the household appliance detects that the hand recedes from the proximate region of the sensor. No action is performed. If the user has selected an operating mode, then the display remains at the selected program. If the user has not selected anything, then the display remains at operating modes.

In a sixth scenario, a baking oven or a steam cooker senses, via the further sensor in the control panel, an approach of a hand. The hand is located at a distance within the proximate region of the sensor. The hand should be sensed for a period of from 100 ms to 500 ms, in particular 200 ms, in a sensing region between 30 cm and 15 cm in front of the appliance. The cooking chamber door of the baking oven or steam cooker opens.

In a further scenario, the household appliance detects, via the sensor in the control panel, a swiping gesture of a hand. The hand is located at a distance within the proximate region of the sensor. Depending on the swipe direction, the displayed image scrolls left or right.

In the case of a baking oven or steam cooker, it is conceivable to detect, via the sensor in the control panel, whether an object, such as, for example, a head of a person, is approaching a cooking chamber door. Here, the object is located at a distance within the additional region of the sensor. Such a further sensing region of the sensor is shown, for example, in FIG. 1. As an action, the cooking chamber light is turned on.

Moreover, it may be detected, via the sensor in the control panel, whether a person recedes from the remote region of the sensor. In this case, the signal tones of the appliance may be turned louder correspondingly. If no operating mode has been selected, the display changes to time display.

Optionally, a backlight is turned off to save power. If an operating mode has been selected, the display may display, for example, a remaining time.

The actions performed and the contents displayed depending on the detected gestures are described merely by way of example and may be selected or modified as desired.

For example, an exhaust hood may be configured with a sensor for detecting, for example, whether a cooking vessel, such as a pot or pan, is placed onto a cooktop.

Upon detection of the cooking vessel, user control of the cooktop may be activated. In addition, a light of the exhaust hood may be turned on.

The exhaust hood may be adapted to sense, using the sensor, non-contact swiping gestures within the proximate region of the sensor. Depending on the gesture detected, an exhaust flow rate of the exhaust hood may be adjusted.

If, instead, approaching gestures are sensed in the proximate region, then the light may be dimmed up or down depending on the gesture.

A refrigerating appliance, such as, for example, a refrigerator or freezer, may be adapted to recognize an open gesture in the proximate region in response to the detection of an approaching person in the remote region. In response to the detection of the open gesture, for example, a door of the refrigerating appliance may be pushed open by a motor drive.

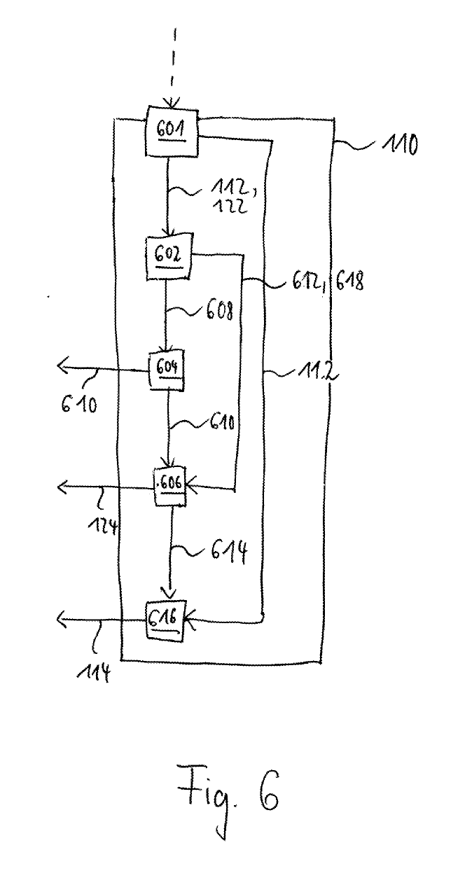

FIG. 6 shows a block diagram of an apparatus 110 for operating a household appliance according to an exemplary embodiment of the present invention. Apparatus 110 may, for example, be an apparatus such as that described with reference to FIGS. 1 through 5.

Apparatus 110 includes an evaluation unit 602, a providing unit 604, as well as an output unit 606. In accordance with this exemplary embodiment, evaluation unit 602 is adapted to receive sensor signals 112 via an interface 610 to the sensor, and to evaluate, using sensor signals 112, the movement of the user sensed by the sensor. Evaluation unit 602 is further adapted to send a first detection signal 608 to providing unit 604 if the evaluation shows that the movement is an approaching movement of the user relative to the household appliance that is detected in the first sensing region.

In accordance with FIG. 6, providing unit 604 is adapted to provide, using first detection signal 608, a switch-on signal 610 and send the same to output unit 606 and to a controller of the household appliance, such as, for example, the controller described with reference to FIG. 1. The controller is adapted to place the household appliance in a state of operational readiness using switch-on signal 610.

If evaluation unit 602 detects, using sensor signals 112, an approaching movement in the second sensing region of the sensor, then it generates a second detection signal 612 and transmits the same to output unit 606.

Output unit 606 is adapted to output an activation signal 614 using second detection signal 621 and switch-on signal 610.

In accordance with this exemplary embodiment, apparatus 110 further has an analysis unit 616 adapted to receive activation signal 614 from output unit 606 and sensor signals 112 from interface 601 and to perform control-movement recognition using signals 112, 614. If analysis unit 616 recognizes a further movement of the user sensed by the sensor as a control movement, then it generates control signal 114 for controlling the household appliance, which control signal may be received and processed by the controller.

Additionally or alternatively, the controller may receive and process activation signal 614. The controller may be implemented with a control-movement recognition function, which may be activated using activation signal 614.

Evaluation unit 602 may, for example, be adapted to receive further sensor signals 122 from a further sensor of the household appliance via interface 601 and to detect, using further sensor signals 122, an approaching movement of the user that is sensed in a further sensing region of the sensor. In this case, evaluation unit 602 generates a corresponding further detection signal 618. Output unit 606 is adapted to receive further detection signal 618 and generate further control signal 124 using further detection signal 618.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

What is claimed is:

1. A method for operating a household appliance having at least one sensor for detecting a user of the household appliance, the method comprising the following steps:
evaluating a movement of the user sensed by the sensor;
providing a switch-on signal configured to place the household appliance in a state of operational readiness based on, in the evaluating step, the movement being recognized as an approaching movement relative to the household appliance that is sensed in a predetermined first sensing region; and
outputting an activation signal configured to activate a control-movement recognition function of the household appliance using the switch-on signal based on, in the evaluating step, the movement being recognized as an approaching movement relative to the household appliance that is sensed in a predetermined second sensing region.

2. The method of claim 1, wherein the first sensing region is farther away from the household appliance than the second sensing region.

3. The method of claim 1, wherein, in the outputting step, the activation signal is output based on, in the evaluating step, the movement being recognized as an approaching movement of a body part of the user relative to the household appliance that is sensed in the second sensing region.

4. The method of claim 1, wherein at least one of the switch-on signal is provided in the providing step or the activation signal is output in the outputting step based on, in the evaluating step, the movement being recognized as an approaching movement relative to the household appliance that lasts for a predetermined approach period.

5. The method of claim 1, further comprising a step of generating a change signal configured to change at least one of a display or a signal tone volume of the household appliance using at least one of the switch-on signal or the activation signal.

6. The method of claim 1, further comprising a step of analyzing a further movement of the user sensed by the sensor via the control-movement recognition function, using the activation signal.

7. The method of claim 6, wherein a control signal configured to control the household appliance is generated in a generating step based on, in the analyzing step, the further movement being recognized as a control movement for non-contact control of the household appliance.

8. The method of claim 7, wherein, in the generating step, the control signal is generated based on, in the analyzing step, the further movement being recognized as a control movement that is sensed in the second sensing region.

9. The method of claim 7, wherein, in the generating step, the control signal is generated based on, in the analyzing step, the further movement being recognized as a control movement that lasts for a predetermined control operation period.

10. The method of claim 1, wherein, in the outputting step, at least one further control signal for controlling the household appliance is output using the switch-on signal based on, in the evaluating step, the movement being recognized as an approaching movement relative to the household appliance that is sensed in at least one predetermined further sensing region.

11. The method of claim 10, wherein the further sensing region is oriented in a different direction than at least one of the first sensing region or the second sensing region.

12. The method of claim 1, wherein, in the evaluating step, at least one additional movement of the user sensed by the sensor is evaluated.

13. The method of claim 12, wherein, at least one additional control signal configured to control the household appliance is sent in a sending step based on, in the evaluating step, the additional movement being recognized as a receding movement relative to the household appliance.

14. An apparatus configured to perform all steps of the method of claim 1.

15. A household appliance comprising:
the apparatus of claim 14; and
at least one sensor configured to detect a user of the household appliance.

16. A machine-readable storage medium having stored thereon a computer program executable by a computer processor to perform a method for operating a household appliance having at least one sensor for detecting a user of the household appliance, the method comprising:
evaluating a movement of the user sensed by the sensor;
providing a switch-on signal configured to place the household appliance in a state of operational readiness based on, in the evaluating step, the movement being recognized as an approaching movement relative to the household appliance that is sensed in a predetermined first sensing region; and
outputting an activation signal configured to activate a control-movement recognition function of the household appliance using the switch-on signal based on, in the evaluating step, the movement being recognized as an approaching movement relative to the household appliance that is sensed in a predetermined second sensing region.
